(19) United States
(12) Patent Application Publication
(10) Pub. No.: US 2008/0063467 A1
(43) Pub. Date: Mar. 13, 2008

(54) Multifunctional connector for biomedical lines

(75) Inventor: Luca Ferrari, Carpi (IT)

Correspondence Address: MODIANO & ASSOCIATI, Via Meravigli, 16, MILAN, 20123, omitted

(73) Assignee: LUCOMED SPA

(21) Appl. No.: 11/642,521

(22) Filed: Dec. 21, 2006

(30) Foreign Application Priority Data
Sep. 7, 2006 (IT) MO2006U000018

(51) Int. Cl. F16L 41/00

(52) U.S. Cl. 403/169

(57) ABSTRACT

A multifunctional connector for biomedical lines, comprising a main duct provided with at least one inlet and at least one outlet for a fluid, which can be associated with a flow line and from which at least one withdrawal and/or infusion branch and at least one service duct associable with a shunt line branch out. The service duct comprises a connecting portion which is connected to the main duct and a coupling portion which can be associated with a shunt line, the portions being mutually inclined and connected.

The present invention relates to a multifunctional connector for biomedical lines.

### BACKGROUND OF THE INVENTION

Multifunctional connectors for biomedical lines, used particularly for transfusions, infusions and hemodialysis, are known which are cross-shaped and comprise a main duct for the passage of a physiological fluid, generally blood, which is intersected at right angles by a withdrawal and/or infusion branch and by a service duct, which are mutually axially offset.

The main duct is provided, at its opposite ends, with an inlet and an outlet, which are mutually coaxial and lie on substantially mutually parallel planes.

The inlet and the outlet of the main duct can be associated detachably with a flow line, which comprises a supply tube and an outflow tube for the processed physiological fluid.

The withdrawal and/or infusion branch is provided, at its opposite ends, respectively with an opening for connection to the main duct and with a free opening which can be accessed from the outside, said openings being mutually coaxial.

The withdrawal and/or infusion branch comprises, in its end portion, proximate to the free opening, a plug made of synthetic latex, which is held in place by an interlocking lid. Such plug is suitable to be pierced with a needle of a syringe for any withdrawals and/or infusions, and thanks to the elasticity of latex it closes naturally during the extraction of the needle in order to avoid any outflow of fluid.

The service duct is provided, at its opposite ends, respectively with a first port, which is connected to the main duct, and with a second port, which can be accessed from the outside; said ports are arranged on mutually parallel planes which are perpendicular to the planes of arrangement of the inlet and the outlet of the main duct.

A shunt line is coupled detachably to the second port of the service duct and comprises a shunt tube which is generally connected to auxiliary devices, for example a monitor line or a heparin line.

Known connectors are provided monolithically by injection molding and are also provided with protective fins and grip elements which are adapted to facilitate their grip and protect the safety of the operator for example during piercings performed with a needle in withdrawal or infusion operations.

As mentioned, the inlet and the outlet of the main duct and the second port of the service duct are coupled detachably to corresponding tubes, which are generally made of PVC.

The coupling of said tubes to the connector must be hermetic, in order to avoid the escape of blood or other physiological fluid under pressure, which would entail high hygienic and sanitary risks for operators besides damage for the nearby instruments.

These known connectors are thus assembled to the blood conveyance tubes, i.e., so that the inlet and the outlet of the main duct are coupled respectively to the blood supply tube and to the blood outflow tube and so that the second port of the service duct is coupled to the shunt tube.

Since the tubes can have different lengths, they are wound around said connector and in particular around the main duct so as to minimize overall bulk in order to facilitate packing, transport and storage.

These known connectors are not free from drawbacks, including the fact that winding the tubes around them in order to facilitate their packing entails bending said tubes, especially at their regions for coupling to the connector.

This bending is particularly sharp at the region where the shunt tube is coupled to the service duct, since the second port of the latter is arranged on a plane which is parallel to the longitudinal axis of the main duct, around which the tubes are wound.

This bending, especially if prolonged over time, can cause a permanent deformation of the tubes and in particular of the portion for connecting the shunt tube to the second port of the service duct, consequently forming internal chokes, which as mentioned entail an increase in load losses during the outflow of blood or other physiological fluid.

Another drawback of known connectors is that although the openings of the withdrawal and/or infusion branch and the ports of the service duct are mutually axially offset and parallel, during the piercing of the latex plug which closes the free opening of the withdrawal and/or infusion branch an incorrect inclination of the needle can accidentally damage or pierce the shunt tube which is coupled to the second port of the service duct.

### SUMMARY OF THE INVENTION

The aim of the present invention is to eliminate the drawbacks noted above of known connectors, by providing a multifunctional connector for biomedical lines which allows to avoid the bending of the shunt tube coupled to the service duct, so as to prevent the formation of chokes inside it.

Within this aim, an object of the present invention is to provide a connector which allows to prevent damage or piercing of the shunt tube coupled to the service duct by the needle when it is inserted in the plug of the withdrawal and/or infusion branch, regardless of the length of said needle or of its inclination upon insertion.

Another object of the present invention is to provide a connector which is simple, relatively easy to provide in practice, safe in use, effective in operation, and has a relatively low cost.

This aim and these and other objects that will become better apparent hereinafter are achieved by the present multifunctional connector for biomedical lines, which comprises a main duct provided with at least one inlet and at least one outlet for a fluid, which can be associated with a flow line and from which at least one withdrawal and/or infusion branch and at least one service duct associable with a shunt line branch out, characterized in that said service duct comprises a connecting portion which is connected to said main duct and a coupling portion which can be associated with said shunt line, said portions being mutually inclined and connected.

### BRIEF DESCRIPTION OF THE DRAWINGS

Further characteristics and advantages of the present invention will become better apparent from the following detailed description of a preferred but not exclusive embodiment of a multifunctional connector for biomedical lines, illustrated by way of non-limiting example in the accompanying drawings, wherein:

FIG. 1 is a perspective view of the connector according to the invention;

FIG. 2 is a rear facing elevation view of the connector according to the invention;

FIG. 3 is a lateral axial sectional view of the connector according to the invention inserted in a biomedical line.

### DESCRIPTION OF THE PREFERRED EMBODIMENTS

With reference to the figures, the reference numeral 1 generally designates a multifunctional connector for biomedical lines.

The connector 1 comprises a main duct 2, within which a physiological fluid, generally blood, flows; an inlet 3 and an outlet 4 are formed at the ends of said main duct and are associable with a flow line. In a preferred embodiment, the main duct 2 is straight and the inlet 3 and the outlet 4 are mutually coaxial.

A withdrawal and/or infusion branch 5 branches out from the main duct 2 and comprises an opening 6 for connection to the main duct 2 and a free opening 7 which can be accessed from the outside.

In a preferred embodiment, the branch 5 is arranged at right angles to the sector of the main duct 2 from which it branches out.

A service duct 8 also branches out from the main duct 2 and can be associated with a shunt line, which comprises a connecting portion 9, connected to the main duct 2, and a coupling portion 13, which is arranged at right angles or inclined with respect to the connecting portion 9, to which it is connected so as to form substantially an elbow.

The connecting portion 9 lies substantially at right angles, or is inclined, with respect to the longitudinal axis of the sector 10 from which it branches out.

The coupling portion 13 instead lies in a direction which is substantially parallel or inclined with respect to the longitudinal axis of the sector 10.

Preferably, the connecting portion 9 and the coupling portion 13 are mutually substantially perpendicular and in the particular embodiment shown in FIG. 3 the connecting portion 9 and the coupling portion 13 lie respectively at right angles and parallel to the longitudinal axis of the sector 10, so as to form substantially an L-shape.

The service duct 8 comprises a first port 11, which is connected to the main duct 2, and a second port 12, which is formed at the end sector of the coupling portion 13 and can be accessed from the outside of the connector 1.

Advantageously, the connecting portion 9 is coaxial to the branch 5.

Seats, designated respectively by the numerals 14a, 14b and 14c, are formed proximate to the inlet 3, to the outlet 4 and to the second port 12 for mating with the ends of corresponding tubes which belong to the flow line and to the shunt line, for example a feed tube 15a, an outflow tube 15b, and a shunt tube 15c.

The seats 14a, 14b, and 14c have a conical shape which diverges outward and end on the bottom with a shoulder, designated respectively by the numerals 16a, 16b, and 16c, for the abutment of the ends of the tubes 15a, 15b and 15c.

In a preferred embodiment, the outside diameter of the tubes 15a, 15b and 15c is equal to, or slightly greater than, the largest inside diameter of the main duct 2 or of the service duct 8 formed by the respective shoulders 16a, 16b and 16c, in order to provide a good seal. The inside diameter of the tubes 15a, 15b and 15c is substantially equal, within ordinary tolerances, to the smallest inside diameter formed by the shoulders 16a, 16b and 16c, in order to avoid excessive turbulence.

The connector 1 comprises one or more protective fins 17, for example two fins 17, which are rigidly associated with its outer surface and lie on a plane which is substantially perpendicular, within ordinary tolerances, to the branch 5 and is arranged, with respect to the longitudinal axis of the main duct 2, toward the branch 5.

The connector 1 also comprises one or more grip walls 18, for example two walls 18, which are formed on the outer lateral surface of the service duct 8.

On the outer surface of each wall 18 there are a plurality of knurled portions 19 suitable to improve their ergonomics.

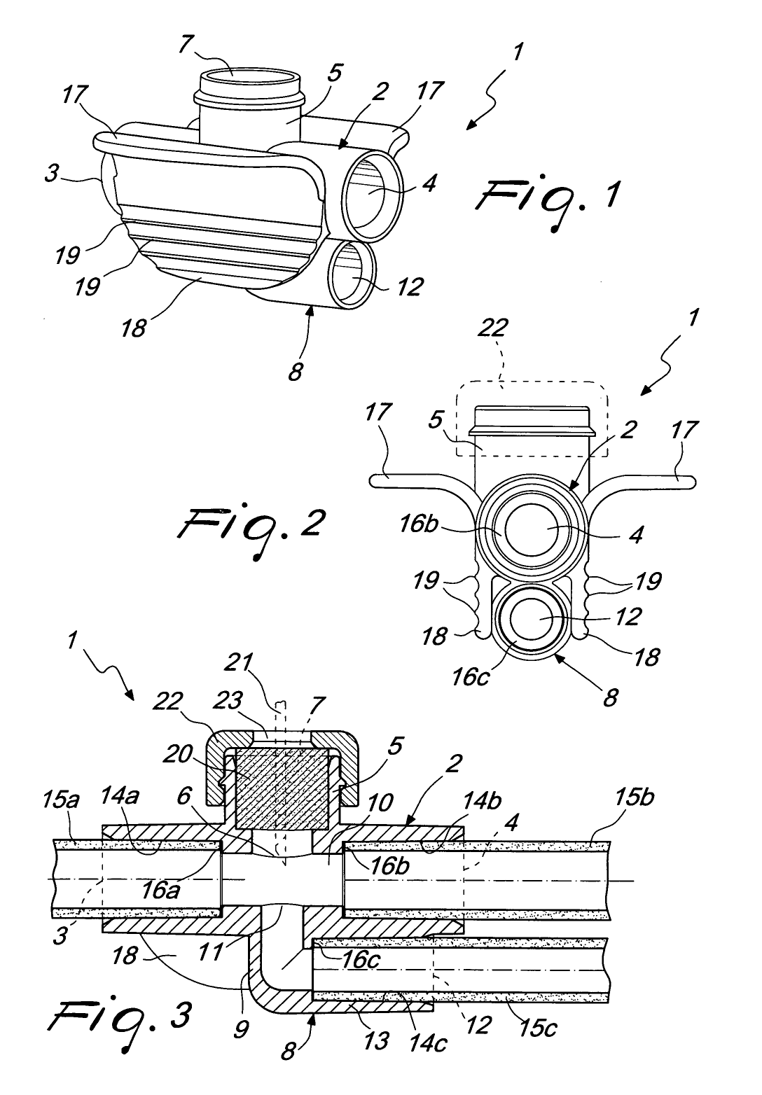

In a preferred embodiment, as shown in FIGS. 1 and 2, each fin 17 is blended with a respective wall 18 so as to form substantially an L-shape.

The branch 5 comprises internally, proximate to the free opening 7, a closure plug 20, for example made of synthetic latex, which is adapted to be pierced by a needle 21 for any withdrawals and/or infusions. The plug 20 is blocked in an upper region by a lid 22, which can be associated, for example by interlocking, with the outer surface of the branch 5 and in which a through hole 23 is formed in a central position; the needle 21 is inserted in said hole.

The operation of the present invention is as follows.

Once the connector 1 has been assembled to the tubes 15a, 15b and 15c, said tubes are wound up.

By way of the arrangement of the connecting portion 9 and of the coupling portion 13, which are mutually inclined and in a preferred embodiment are respectively perpendicular and parallel to the longitudinal axis of the sector 10 of the main duct 2, it is possible to wind the shunt tube 15c without bending it excessively and with sharp angles, thus avoiding its permanent deformation.

The inclination between the connecting portion 9 and the coupling portion 13 further prevents accidental perforations of the shunt line.

During use, the physiological fluid, which arrives from the supply tube 15a inserted in the inlet 3, flows inside the main duct 2 and exits through the outlet 4, to which the outflow tube 15b is connected.

If it is necessary to perform a withdrawal and/or infusion, the needle 21 is inserted within the branch 5 through the hole 23 and the plug 20.

If the needle 21 is inserted with an incorrect inclination, it comes into contact, with its pointed end, with the rigid inside wall of the connecting portion 9 of the service duct 8, without interfering with the shunt tube 15c, whose integrity is therefore safeguarded.

To perform withdrawals or infusions, the operator can grip the connector 1 by means of the walls 18 while remaining in any case protected by the fins 17, which act as a protective barrier against accidental injuries.

The lid 22 is intended to prevent the plug 20 from being drawn out during the step for extraction of the needle 21; this would cause an unwanted escape of the fluid contained in the connector 1.

The service duct 8 is used instead for example to check physiological parameters, such as blood pressure, by making a preset amount of fluid flow out of the main duct 2 toward the shunt tube 15c.

In practice it has been found that the described invention achieves the intended objects and in particular the fact is stressed that it avoids, during packing, the formation of permanent chokes within the tube connected to the service duct.

The particular shape of the service duct, provided with a coupling portion which is parallel to the main duct, avoids the piercing of the shunt tube connected thereto by a needle which is inserted in the withdrawal and/or infusion branch.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements without thereby abandoning the scope of the protection of the appended claims.

The disclosures in Italian Utility Model Application No. MO2006U000018 from which this application claims priority are incorporated herein by reference.

What is claimed is:

1. A multifunctional connector for biomedical lines, comprising: a main duct provided with at least one inlet and at least one outlet for a fluid; a flow line, connected to said main duct; at least one withdrawal and/or infusion branch; and at least one service duct connectable with a shunt line, said at least one withdrawal and/or infusion branch and shunt line branching out from said flow line, and wherein said service duct comprises a connecting portion which is connected to said main duct and a coupling portion which is connectable to said shunt line, said connecting and coupling portions being mutually inclined and connected.

2. The connector of claim 1, wherein said coupling portion is arranged substantially parallel or inclined with respect to the longitudinal axis of a sector of said main duct from which said connecting portion branches.

3. The connector of claim 2, wherein said connecting portion further lies in a direction which is substantially perpendicular or inclined with respect to a longitudinal axis of said sector.

4. The connector of claim 3, wherein said connecting portion and said coupling portion are mutually substantially perpendicular.

5. The connector of claim 4, wherein said connecting portion and said coupling portion lie respectively substantially at right angles and substantially parallel to the longitudinal axis of said sector.

6. The connector of claim 1, wherein said main duct is substantially straight, said inlet and said outlet being mutually coaxial at the opposite ends of said main duct.

7. The connector of claim 1, wherein said withdrawal and/or infusion branch is substantially coaxial to said connecting portion.

8. The connector of claim 1, comprising a respective seat for coupling to an end of a corresponding tube of said flow and shunt lines that is formed proximate to said inlet, said outlet and said coupling portion.

9. The connector of claim 8, wherein said seat is conical and diverges outward.

10. The connector of claim 9, wherein said seat comprises at least one abutment shoulder for said end of a corresponding tube.

11. The connector of claim 10, wherein said shoulder has a depth that is substantially equal to a thickness of said tube.

12. The connector of claim 8, comprising at least one protective fin which is rigidly associated with an outer surface of the connector and lies on a plane which is substantially perpendicular to said withdrawal and/or infusion branch.

13. The connector of claim 12, comprising at least one grip wall which is formed on an outer lateral surface of said service duct.

14. The connector of claim 13, wherein said wall has an outer surface that comprises a plurality of knurlings.

15. The connector of claim 13, wherein said fin is blended with said wall so as to form substantially an L-shape.

16. The connector of claim 1, comprising at least one plug for closing a free opening of said withdrawal and/or infusion branch and at least one lid for blocking said plug, a central through hole being formed in said lid.

17. The connector of claim 16, wherein said lid is associated by interlocking with an outer surface of said withdrawal and/or infusion branch.
